(19) United States
(12) Patent Application Publication
(10) Pub. No.: US 2021/0381862 A1
(43) Pub. Date: Dec. 9, 2021

(54) MAGNETIC FLOW METER

(71) Applicant: EICON GMBH, Neufarn/Vaterstetten (DE)

(72) Inventor: Gerhard A. BRANDL, München (DE)

(73) Assignee: EICON GMBH, Neufarn/Vaterstetten (DE)

(21) Appl. No.: 17/286,078

(22) PCT Filed: Oct. 16, 2019
(86) PCT No.: PCT/EP2019/078092

§ 371 Date: Apr. 16, 2021

(30) Foreign Application Priority Data
Oct. 18, 2018 (EP) 18201165.0

(51) Int. Cl. G01F 1/60; G01F 1/58

(52) U.S. Cl. CPC G01F 1/60; G01F 1/584

(57) ABSTRACT

A tubal measuring arrangement and a method for measuring the flow rate of fluid comprising ions, the measuring arrangement comprising at least one permanent magnet adapted to maintain a magnetic field substantially perpendicular to the flow of the fluid, at least one first detecting arrangement being positioned substantially perpendicular to the magnetic field and configured to conduct at least one first measurement, at least one first measuring circuit, at least one second detecting arrangement being positioned substantially along the direction of flow of the fluid, at least one second measuring circuit that is configured to conduct at least one second measurement at the second measuring arrangement, at least one evaluation unit and at least one control unit.

### FIELD

The present invention is directed to a magnetic flow meter that is adapted to quantify the amount of a fluid that passes a part of a tube provided the diameter of the tube is known.

### BACKGROUND

Flow meters in the state of the art are usually equipped with at least one or more impeller(s), thus the flowing fluid forces the impeller to conduct a rotational motion. The rotation of the impeller is used to meter the amount of throughflow. Further, a number of alternative flow meter technologies have been invented like a differential pressure and positive displacement flow meter is the magnetic flow meter, also technically an electromagnetic flow meter. Magnetic flow meters are usually constructed to make use of Faraday's law and therefor needs an alternating magnetic field that induces a measurable value. Magnetic flow meters making use of alternating magnetic fields have been in use since many years.

Further methods that are just referenced here for completion purposes. Such meters make use of ultrasonic influence that is proportional to the flow within a defined tubal environment.

DE 10 2016 125745 (A1), that is addressed as ultrasound flow measuring device for measuring the flow of a medium through a measuring tube with at least two ultrasonic transducers and at least one control and evaluation unit. The measuring tube has an inner wall, the ultrasonic transducers are transmitters for transmitting an ultrasonic signal and/or are receivers for receiving the ultrasonic signal, and are arranged offset in the direction of flow such that the respective transmitter transmits an ultrasonic signal in the direction of flow or against the direction of flow during operation. The receiver receives the ultrasonic signal transmitted by the transmitter after at least one reflection on the inner wall of the measuring tube, the ultrasonic signal having a first signal component and at least a second signal component.

A nuclear magnetic flowmeter has been disclosed with DE 10 2012 013 933 (A1) as a measuring tube through which a multiphase medium can flow and which can be connected to an inlet tube which is located in the flow direction of the medium upstream of the measuring tube and to an outlet tube which is located in the flow direction downstream of the measuring tube. The nuclear magnetic flowmeter is, first of all, characterized essentially in that a medium bypass is assigned to the measuring tube, that the medium bypass includes a bypass tube, an inlet valve and/or an outlet valve and that, for a calibration operation, the bypass tube, on the one hand, can be connected to the inlet tube, and on the other hand, to the outlet tube, specifically via the inlet valve, via the outlet valve or via the inlet valve and via the outlet valve.

With EP 3 301 409 (A1) a measuring tube and a magnetic-inductive flowmeter is disclosed. The invention relates to a measuring tube and a magnetic induction flowmeter. Especially, the measuring tube is inserted in a measuring tube receiver of a magnetic-inductive flowmeter to guide a medium, the measuring tube has two electrodes for tapping a voltage induced in the medium, wherein the electrodes each extend at least from a medium contact area to a connecting contact area on one end for connection to an evaluating unit. The electrodes are respectively arranged on both sides of the measuring tube in an electrode plane situated perpendicularly on the longitudinal axis of the measuring tube and the electrodes extend parallel to one another and tangential to the measuring tube.

DE 10 2015 116 771 (A1) makes use of an alternating magnetic field setting a constant magnetic field strength of a magnetic field within a commutation interval using a magnetic-inductive flowmeter having a current controller with which time for setting the constant magnetic field strength of a magnetic field is relatively shorter. Additionally, a first interval having a starting point in time and an ending point in time and a second interval having a starting point in time and an ending point in time are arranged within a commutation interval. A first setpoint current curve for the first interval differs by a difference current curve to effectuate a higher rate of change. A second setpoint current curve is assigned to the constant setpoint current. The current controller is fed the first and second setpoint current curves.

All of the above inventions require a power supply to support the metering devices to a considerable extent. Establishing and maintaining an alternating magnetic field presupposes a permanent flow of electric energy. While this may be a suitable method to measure larger installations, such installations that are supported by a professional organization to maintain the power source and supply, this appears less suitable for private and/or small business solutions. Therefore, systems requiring only battery-based power supply using batteries lasting for years, even a decade or longer, have been invented utilizing permanent magnets.

Such an invention is PCT/EP2014/061534 that relates to a measuring device for measuring a flow rate of an electrically conducting medium in a volume which is permeated by a magnetic field, comprising a device for producing the magnetic field, at least one resistor, at least two electrodes, the at least two electrodes being electrically interconnected via the at least one resistor, and an evaluation unit for evaluating the measurement signal of the electrodes measured in parallel to the at least one resistor, and for calculating the flow rate.

Further, another invention PCT/EP2012/057939 points into the field. The invention relates to a measuring apparatus for measuring the flow velocity of an electrically conductive medium in a volume permeated by a magnetic field, having a means for producing the magnetic field, at least two electrodes and an evaluation unit which evaluates a signal from the electrodes and calculates the flow velocity, wherein the at least two electrodes are connected to a switch which is designed to short-circuit the electrodes.

The latter two inventions comprise permanent magnets and thus don't consume energy just to excite or maintain the magnetic field. However, another problem may arise. Once the short circuit has been released (and water flows) the electrodes detect an electric tension that reflects a measure of the velocity of the flow. However, further to the significant tension also electro-chemical reactions may occur that induce a further tension on top of the useful signal. Further, electro-chemical reaction can occur and induce an electric tension/current just from the existence of electrodes in a fluid, no matter whether a magnetic field, a fluid motion or any other influence acts. Over the time that lapses, changes of the tension/current can be observed. Experience and thorough adjustment procedures are needed to calibrate the flow meter. Usually, the signal deriving from the chemical reaction, also referenced as noise signal or just noise, is very difficult to predict. Variables can be the height of the external influence (magnetic field, electrostatics), but also from the properties of the fluid, fluid temperature, pressure of the fluid and, last not least, by the material of the electrodes. Further parameters may have effect. Although general predictions can be made if the quality of the fluid, i.e. water, is known like in industrial countries, where the local water companies supply relevant data, the regional calibration of the water meters may be critical.

All the aforementioned documents are herewith incorporated by reference.

### SUMMARY

The problem underlying the present invention is to provide an improved or ameliorated system of a magnetic flow meter comprising at least one permanent magnet with a compensated and/or calibrated metering of the flow of a fluid.

The problem can be solved by the subject matter of the present invention an as further exemplified by the description and the claims.

A metering device for a fluid may be constructed to be a tubal measuring arrangement for measuring the flow rate of a fluid. The fluid may be considered to comprise ions. Thus, charge carriers as constituted by an ion-carrying fluid can move through a tube or a lumen that allows a fluid to be transported in a substantially flowing motion.

At least one permanent magnet may be adapted to maintain a magnetic field that is substantially perpendicular to the flow of the fluid. The “Three-Fingers-Rule” may be applied to understand the Lorentz force. The flow direction of the fluid and the field of the permanent magnets may be substantially perpendicular.

At least two electrodes that can reach into the fluid, thus comprising a direct contact between the fluid and the electrodes may form one first detection arrangement. The imaginary line between the two electrodes can be placed substantially in another right angle—a right angle against the magnetic field and a right angle against the flow direction. Again, the “Three-Fingers-Rule” may apply to demonstrate the relational directions of the flow, the magnetic field and the imaginary line between the electrodes.

If the fluid moves, part of the fluid or rather the ions in the fluid will be moved by the Lorenz force both orthogonal to the movement direction of the fluid and orthogonal to the magnetic field and thus an electric signal can be detected by the first detection arrangement, as known by the physicist. As long as the angle relation is obeyed as described above and below, i.e., the flow, the magnetic field and the imaginary line between the electrodes are spatially right angled, the maximum of induced force can be detected by the electrodes of the first detection arrangement.

Where the relation of two or more axes are explained to be oriented orthogonally, further compositions are meant that comprise a relation to each other, where at least an orthogonal component is given. Thus, according to the trigonometric functions, a measured value due to an angled relation of two or more axes, the sine function may be applied as a factor. More precisely, if two axes are parallel, the value of the sine of 0°, which is 0, would result in no value to be delivered (any random value divided by 0 would experience an invalid result). The person skilled in the art will know that an angle of 90° between two axes will result in an optimum, because the sine of 90° is equal to the value 1—and the theoretical value will be divided by 1 and will result in the full value that can be derived from an installation. However, under certain circumstances, an angled arrangement unequal to 90° may be applied for technical reasons. In such a case, the value of the sine function related to that angle may be corrected by the measured actual tension/current.

Anyhow, the technician skilled in the art will apply every effort to construct the tubal measuring arrangement so that an optimum of accuracy can be achieved. This means, if ever possible, the 3 axes will as close as possible be arranged in spatially arranged right angles.

It should further be clear that this angular relation between two axes can be applied to a spatial arrangement, thus referencing a spatial coordinate system of the axes. The axes in this context may be the magnetic field, the imaginary line between the electrodes and the flow direction of the fluid.

A number of such first detection arrangements may be placed so that the first detection arrangement, either in line downstream (or upstream) the other first detection arrangement. The optional further first detection arrangement(s) may differ with the angle of their imaginary line(s) so that a resultant value may be output, that may be a function of the cosine of the angle between the imaginary line(s) of the electrodes.

A second detection arrangement may be provided downstream or upstream or in close proximity to the first detection arrangement that can have its electrodes substantially in line (i.e. substantially parallel) to the flow direction of the fluid or to the magnetic field. According to the rules of the Lorentz force no—or at least a significantly lower—induced signal can be detected by this second detection arrangement. Whereas the Lorentz force can induce tension to the electrodes of the at least one first detection arrangement, an electric potential can be applied to the electrodes of the second detection arrangement. This electric potential can be originating from electro-chemical effects. The value of this signal may be interpreted as the noise signal.

A set of second detection arrangements may be provided to increase accuracy of the value(s) delivered by the second detection arrangement(s). A variation of the material of the electrodes, their shape, their location may further increase the accuracy of the determined value.

The one first detection arrangement may deliver an analogue signal; this signal can be a tension or a current. A first measuring circuit may convert the analogue signal that may have been delivered from the first detection arrangement into a digital value.

Each first detection arrangement may deliver its analogue signal to an individual first measuring device; additionally, or alternatively, one first measuring device may be served by more than one first detection arrangement and deliver the resulting digital values for further processing.

The one second detection arrangement may deliver an analogue signal; this signal can be a tension or a current. A second measuring circuit may convert the analogue signal that may have been delivered from the second detection arrangement into a digital value.

Each second detection arrangement may deliver its analogue signal to an individual second measuring device; additionally, or alternatively, one second measuring device may be served by more than one second detection arrangement and deliver the resulting digital values for further processing.

The resulting digital value(s) that is/are delivered by the first measuring device and/or by the second measuring device may be delivered to an evaluation unit. This evaluation unit can conduct calculations related to the received value(s), such as put the value(s) into relation. At least one pre-stored correction factor may be applied. The values delivered by the second measuring device may be subtracted from the values that have been delivered by the first measuring device, thus finding a value that is at least partially compensated by the effect of electro-chemical reaction. The processed values may be either raw, mean or evened values or any combination thereof.

Further, also the analogue values that can be delivered from the first and/or the second detection arrangement(s) can be subtracted by a suitable method known by the person skilled in the art.

More than one evaluation unit(s) may be provided that can detect further details in the derived data set that has been delivered by the preceding elements of the metering arrangement.

Further, the evaluation unit may deliver at least one value to a control unit that can carry out control signals or control actions.

More than one control unit may be provided for various reasons. One reason could be that more than one control action must/shall be carried out dependent from the results delivered from the at least one evaluation unit. A more likely reason could be that the control unit must carry out actions in wide ranges—from controlling a switch that can be integrated in the metering arrangement in very short time slices, while another control unit may initiate action like starting an alarm signal or the closure of the water supply.

In one embodiment, the first detecting arrangement can comprise at least two electrodes. Such electrodes can have various shapes. One example is a pointed shape that reaches into the fluid to establish a direct contact with the fluid. In another example, the electrode can comprise a substantially flat shape, which can enlarge the area where the fluid is in contact with the electrode. Further, a net-like structure can be applied.

Further, the second detecting arrangement may comprise two electrodes; it should however be clear from the description that more than two electrodes can be configured. This allows redundancy, i.e., measurements between different point that may occur either independently or in a form of a time-sharing system, so that values between 2 points may be taken and processed at a later stage.

One electrode of the second detection arrangement may be identical with one of the electrodes with one of the first electrodes. Thus, as long as at least one pair of second electrodes with their imaginary connection line are parallel to the flow direction of the water or parallel to the magnetic field, no or at least a very low signal related to the flow velocity may be induced. Between these two electrodes, only the noise signal can be detected. Due to the nature of the Lorentz rule the point at the origin of the imaginary coordinate system may be used as a reference for all axes. Thus, one electrode can be located at the origin of the imaginary coordinate system, while a further electrode can be located so that an imaginary line results that is substantially perpendicular to the magnetic field and substantially perpendicular to the flow direction of the fluid (thus forming the first detecting arrangement). The same electrode that is located at the origin of the imaginary coordinate system can also serve as one electrode of the second detecting arrangement, provided it is located perpendicular to the imaginary line between the electrodes of the first detection arrangement (and thus forming the second detection arrangement).

The first measuring circuit can accept the analogue readout of the first detecting arrangement, as disclosed above. And while the second measuring circuit may accept the analogue readout of the second detection circuit, those two measuring circuits may be either integrated into one housing. Further, a switching arrangement may alternatively distribute the readout values from the first detecting circuit and from the second detecting circuit into one single control circuit.

The electrodes belonging to the first detecting arrangement can be adapted to be fixedly or releasably be connected by a resistor. This resistor may be assumed to be above 1 MΩ in value, however, larger values than 1 GΩ may be assigned. Further, the first measuring circuit may comprise such an internal resistance.

The first detection arrangement may further, in parallel to its electrodes and also parallel to an optional resistor, be subject to a switch that is adapted to carry out a short circuit to the at least two electrodes that form the first detection arrangement. That switch can be arranged to change its switching state at high frequencies, the frequencies lying below 10⁹ Hz. The switch may be considered optional. The switch may further be adapted to be controlled by a device that is disclosed below, in the embodiments and in the claims.

The first measuring circuit may be adapted to conduct a first measurement, while the second measuring circuit may be adapted to conduct a second measurement. What is measured depends on the elements connected to the corresponding electrodes. Usually, this will be an electric tension (a voltage), an electric current (amperage) and/or an electric charge or rather the transfer of a charge.

While according to the Lorentz rule, the 3 axes can preferably be oriented perpendicularly to each other in space, thus forming a spatial coordinate system, this case isn't mandatory. The angles may differ from the 90° angle and even come close to each other, at least as long as different signals are detected and/or resultants that differ. It should be noted that the optimum can be assumed if substantially right angles are considered. As long as the signal deriving from the first detecting arrangement and the signal derived from the second detection arrangement differ, a certain adjustment to the signals can be achieved and such a configuration shall be covered by this invention.

A timer module or a timer function within one of the modules (first detecting arrangement, second detecting arrangement, first measuring circuit, second measuring circuit, evaluation unit and/or control unit) may be adapted to carry out a number of timed control functions. One of the functions may be the control of the switch that is logically located parallel to the electrodes of the first detecting arrangement. The switch may be operated at high frequencies, such as below 1 GHz, preferably somewhere around 1 MHz (10⁶ Hz). Further, this frequency may be pulsed, i.e., the high frequency can be applied to the switch in pulses that may vary from 1 ms (10⁻³ s) to one second and even higher according to the best practice in a given environment. In an embodiment, at least one short pulse with a length of around 1 ms (10⁻³s) to 1 s may render sufficient measured values for further computation.

Usually, the first measuring circuit and/or the second measuring circuit or, in cases, where both measuring circuits are configured to act like one single measuring circuit, such a measuring circuit may be addressed as an analogue to digital converter, a device that is adapted to convert analogue signals into digital values. An abbreviation for such a device can be ADC.

The electrodes of the second detecting arrangement may be located in a substantially perpendicular direction to the electrodes of the first detecting arrangement. As known from Lorentz law, a value derived from the motion of the flow of the fluid must originate from the positioning of the first detecting arrangement that is located perpendicular to the magnetic flux lines (i.e. imaginary lines between the poles of one magnet or the imaginary lines between two magnets. Thus, if the second detecting arrangement is located substantially perpendicular to the axis of the first detecting arrangement, no, or at least a minor signal corresponding to the movement of the fluid can be taken from this second detection arrangement. The value that can be derived from the second detection arrangement may be considered of a noise signal that is induced by electro-chemical reaction. This said, it may be considered clear that the electrodes of the second detection arrangement may be quasi parallel to the magnetic axis and/or substantially parallel to the flow of the fluid. More than one second detection arrangements may be adapted to comprise both axes, the one along the flow of the fluid, the other along the magnetic axis. This embodiment may be used to reconfirm electronically the value derived from the corresponding other second detection arrangement.

It should be clear that the magnetic field substantiating the measuring areas of the first and/or the second detection arrangement can be conducted by proper positioning of the one or more magnet(s). Thus, it may be a preferable embodiment, if two or more magnets are used, the magnets should be arranged in a way that the flux lines supply a field that as good as possible supplies a homogeneous field.

As disclosed above, an optional resistor that can be arranged in parallel to the electrodes of the first detection arrangement can be either a discrete element or an internal resistance of the first detecting arrangement. Further, a resultant resistance may be effective that can be calculated obeying Ohm's law.

The fluid that has been referenced can comprise water particles of a wide variety of quality—from drinking water via grey water to black water. Further, any fluid can be comprised that carries a minimum of charged particles like ions or electrons constitute. Also, a liquid comprising considerable amounts of gas may be comprised. A gas can also be considered as long as the gas obeys the requirement of carrying charged particles, positive or negative.

To ensure a suitable operability, the electrodes may be made of or comprise at least to the surface that is exposed to the fluid, a material that is substantially inert to dissolution by the fluid.

Further, the electrodes can be made of or comprise, at least to the surface, an electrically conducting material that is substantially inert to chemical reaction(s). This condition may further apply if an electric tension or an electric current is impinged to the electrodes.

The electrically conducting material of the electrodes, according to the prior disclosed necessities, may comprise at least one of gold, platinum, titanium, stainless steel, a polymer, ceramic and/or carbon tubes.

On an occasional basis, the electrodes may be applied to an electric tension or an electric current that can be of the opposite polarity than the tension/current that is harvested from the fact of the flow of the fluid in the magnetic field. Occasional in this respect means that the exposure of the electrodes to such a tension/current can be initiated during a maintenance event and/or on a basis when long term observations of the involved course indicate a prospective change of the properties of the electrodes. Such an exposure may be restricted to any pair of electrodes or to all combinations of electrodes wherever this might be advantageous.

In order to prevent or reduce unwanted electro-chemical reactions, an alternating tension/current (AC) can be applied.

The exposure of the electrodes according to the above said, may be dimensioned significantly higher than the values of the induced tension/current during normal operation.

The at least one evaluation unit may be adapted to accept the digital values delivered from at least one of the first measuring circuits and/or from the at least one second measuring circuit. The evaluation unit may be a programmable circuit in a manner that can be assumed widely used in the industry—either by a fixed program that can be unchangeable (stored in a ROM or a PROM)—or by a provision that allows changes and adaptions to the needs on site. Such a program can be stored in provisions like an EPROM or an EEPROM. The programming part of the evaluation unit may be distinct or integrated from the storage of characterizing values. The storage provision may comprise values regarding the fluid hardness, the temperature, the electrical conductivity of the fluid, the viscosity of the fluid, the diameter of the tube, the profile of the tube, the number and/or the properties of the electrode(s), maximum or minimum values of the flow rate. This list is exemplifying possible definition values but not restricting further characterizing parameters.

The electrical conductivity can further be measured and fed into the evaluation unit by an arrangement known to the person skilled in the art.

The evaluation unit can further be adapted to carry out comparing calculations, i.e. put the readout of the one measuring device into relation with another measuring device. One typical computation may be a subtraction of the readout provided by the second measuring circuit from the readout that can be provided by the first measuring circuit. Other computations or computational steps may be comprised. Other typical calculations may be comparing characteristic curves of the historical course of earlier measuring curves. To carry out such comparisons, a storing space of values or characteristics may be provided within the evaluation unit and/or externally.

The evaluation unit may further be adapted to initiate control signals; for instance, the control of the switch that is electrically parallel to the electrodes of the first detecting arrangement may be controlled by the evaluation unit, but other control instances may be provided. Further, a wakeup signal may be triggered to a further unit like a separate control unit may constitute. This sort of wakeup trigger to other elements of the tubal measuring arrangement may be advantageous to reduce power consumption of the measuring arrangement in light of the capacity of the power supply.

A further input to the at least one evaluation unit may be the voltage of a power supply that may be provided by a battery arrangement to supervise the power consumption and/or the status of the elements of the measuring arrangement.

The evaluation unit may further process each signal arriving at the evaluation unit by at least one smoothening algorithm and further may, additionally or alternatively, filter values. Erroneous values may be filtered out and/or may be subject to smoothening algorithms. Further, mathematical methods may be applied.

The filter—, smoothening and/or mathematical algorithms may be at least one of a Kalman, a Particle and/or a “David-Donoho” compressed sensing algorithm.

The evaluation unit may further store its values, be them input values or output values, for immediate and/or later use. One immediate use may be display on a display provision. The display may indicate current value(s), average value(s) and/or accumulated value(s) or any combination thereof. Further, any value and/or an output signal that may be initiated by the evaluation unit may be transmitted via a network on demand or on a regular basis.

In addition, or alternatively, the evaluation unit may send at least one signal to a control unit that may control several functions.

The evaluation unit may further receive signals from external sources, like a wearable computer would constitute. Such signals may be re-programming commands to the program that drives the evaluation unit itself and/or characterizing values. Further, inductive charging of batteries may be conducted from an external source.

Further, the measuring arrangement may be adapted to comprise a magnetic field detector that can detect changes of the magnetic field. The evaluation unit may accept the signal that is output by the magnetic field sensor for internal use or for initiating a control signal to whom it may concern.

The internal use may be the storage of such an event and/or the application of a correctional factor to the readout(s). A control signal may be output to a display, to a control unit and/or to an external device via the network.

It should be understood that the separated elements forming the measuring arrangement, the various arrangements, circuits and units may be integrated into one housing or even within one chip. Any combination of elements may be combined and appear as one element, for instance, the first and/or the second measuring circuit may be formed by one two (or more) channel chip. Further, a combination of one (or more) of the measuring circuits with one or more evaluation unit(s) may be combined. Further, also the control circuit may be integrated in any of the other elements of the tubal measuring element. Even the whole measurement arrangement can be adapted to comprise all or a part of the various elements. They may form an inextricable unit.

The measuring arrangement may be protected against electro-magnetic, electrostatic or other affect by providing at least one, usually two grounding provision(s) down—and/or upstream of the measuring arrangement and/or to supply a ground potential.

The evaluation unit can be logically positioned behind the first measuring circuit and may comprise at least one storage that can comprise tabular data. Such data may result from characteristics of the electro-chemical tension over the time lapsed during measurement to reduce the detected tension. Such a look-up table may be stored in an element of the evaluation unit and thus acquire data that can be assumed to be useful data, useful for various reasons.

Further, a method to measure the flow rate of a fluid comprising ions is disclosed. The method can comprise the steps of providing a magnetic field. The magnetic field may be originating from at least one permanent magnet substantially perpendicular to the flow of the fluid. The magnetic field may further be provided by arranging two magnets substantially in line with the axis of the magnetic field. The two magnets may be allocated in line but on substantially opposing sides of the measuring tube. Thus, the magnetic field applied to the lumen where the fluid passes can be assumed to be more stable and more intense. This may be advantageous for receiving higher measurement values. However, it should be clear that an allocation of a second magnet is an option.

At least one first measurement may be conducted by providing at least one first measuring arrangement. The first measuring arrangement may be positioned substantially perpendicular to the magnetic field. By this positioning, a valuable readout may be achieved. The first measuring circuit may deliver its readout to at least one first measuring circuit.

Further, at least one second detecting arrangement can be positioned substantially along the direction of flow of the fluid. With this method, a least influence of the magnetic field may be provided, thus inducing a minor share of tension or current that can be induced by the flow of the fluid through the magnetic field. Thus, the main portion of the detected tension/current can originate from an electro-chemical process induced by a reaction between the electrically conducting electrode(s) and the fluid. The analogue value detected by the second detecting arrangement may be conveyed to a second measuring circuit that may convert the analogue value into a digital value, that is, a number representing an approximation to the analogue value.

Further, at the analogue portion of the arrangement, also analogue provisions may be applied that supply values that are comparable to digitally subtracted values.

The digital value derived from the second measuring circuit may be fed into at least one evaluation unit(s). The evaluation unit may conduct calculations according to a programmed instruction sequence that can comprise filtering, smoothening and/or selectioning procedures. Further, stored and/or measured further values may influence the evaluation unit to calculate at least one value that can be useful in the embodiment.

The evaluation unit may convey its result(s) to a control unit that may carry out a selection of measures. Such a measure may be—exemplary but not excluding other measures—initiating an alarm signal in case of an excess of amount of flow, a steady low leakage may have been detected or changes in the orientation of the magnetic field.

Another method to measure the flow rate of a fluid comprising ions may comprise the steps of steps providing a magnetic field. The magnetic field may be originating from at least one permanent magnet substantially perpendicular to the flow of the fluid. The magnetic field may further be provided by arranging two magnets substantially in line with the axis of the magnetic field. The two magnets may be allocated in line but on substantially opposing sides of the measuring tube. Thus, the magnetic field applied to the lumen where the fluid passes can be assumed to be more stable and more intense. This may be advantageous for receiving higher measurement values. However, it should be clear that an allocation of a second magnet is an option.

At least one first measurement may be conducted by providing at least one first measuring arrangement. The first measuring arrangement may be positioned substantially perpendicular to the magnetic field. By this positioning, a valuable readout may be achieved. The first measuring circuit may deliver its readout to at least one first measuring circuit.

An evaluation unit may accept the digital readout(s) of the first measuring circuit and may apply filtering, smoothening and/or selectioning procedures that can be set by a programmed instruction sequence. Further, stored and/or measured further values may influence the evaluation unit to calculate at least one value that can be useful in the embodiment.

The evaluation unit may convey its result(s) to a control unit that may carry out controlling of a switching device that may be located and logically connected parallel to the first measuring arrangement.

The evaluation unit may convey its result(s) to a control unit that may carry out a selection of measures. Such a measure may be—exemplary but not excluding other measures—initiating an alarm signal in case of an excess of amount of flow, a steady low leakage may have been detected or changes in the orientation of the magnetic field or a combination thereof.

### BRIEF DESCRIPTION OF THE FIGURES

FIG. 1 depicts a view of a tubal measuring arrangement 1 in a schematic aspect of the mechanical arrangement.

FIG. 2 indicates an embodiment of the tubal measuring arrangement 1 in a schematic view of the electronical arrangement.

FIG. 3a-b show embodiments with a reduced set of electronic elements.

FIG. 4a-4c represent a variety of statuses of the tubal measuring arrangement 1 under specific conditions.

FIG. 5 depicts a schematic view of the tubal measuring arrangement 1 further indicating the relational positioning of the elements and further one embodiment of the electronic circuity.

FIG. 6 represents a spatial coordinate system.

FIG. 7 shows the relation of electrodes and induced tensions.

FIG. 8 indicates an effect of angular rearrangement of electrodes and the calculatory provisions

### EMBODIMENTS

While the disclosure has been illustrated and described in detail in the drawings and foregoing description, such illustration and description are to be considered illustrative or exemplary and non-restrictive; the disclosure is thus not limited to the disclosed embodiments. Variations to the disclosed embodiments can be understood and effected by those skilled in the art and practicing the claimed disclosure, from a study of the drawings, the disclosure, and the appended claims.

As used herein, including in the claims, singular forms of terms are to be construed as also including the plural form and vice versa, unless the context indicates otherwise. Thus, it should be noted that as used herein, the singular forms “a,” “an,” and “the” include plural references unless the context clearly dictates otherwise.

The mere fact that certain measures are recited in mutually different dependent claims does not indicate that a combination of these measures cannot be used to fulfill aspects of the present invention. The present technology is also understood to encompass the exact terms, features, numerical values or ranges etc., if in here a relative term, such as “about”, “substantially”, “ca.”, “generally”, “at least”, “at the most” or “approximately” is used in this specification, such a term should also be construed to also include the exact term. That is, e.g., “substantially straight” should be construed to also include “(exactly) straight”. In other words, “about 3” shall also comprise “3” or “substantially perpendicular” shall also comprise “perpendicular”. Any reference numerals in the claims should not be considered as limiting the scope.

In the claims, the terms “comprises/comprising”, “including”, “having”, and “contain” and their variations should be understood as meaning “including but not limited to”, and are not intended to exclude other components. Furthermore, although individually listed, a plurality of means, elements or method steps may be implemented. Additionally, although individual features may be included in different claims, these may possibly advantageously be combined, and the inclusion in different claims does not imply that a combination of features is not feasible and/or advantageous. In addition, singular references do not exclude a plurality.

Whenever steps were recited in the above or also in the appended claims, it should be noted that the order in which the steps are recited in this text may be the preferred order, but it may not be mandatory to carry out the steps in the recited order. That is, unless otherwise specified or unless clear to the skilled person, the order in which steps are recited may not be mandatory. That is, when the present document states, e.g., that a method comprises steps (A) and (B), this does not necessarily mean that step (A) precedes step (B), but it is also possible that step (A) is performed (at least partly) simultaneously with step (B) or that step (B) precedes step (A). Furthermore, when a step (X) is said to precede another step (Z), this does not imply that there is no step between steps (X) and (Z). That is, step (X) preceding step (Z) encompasses the situation that step (X) is performed directly before step (Z), but also the situation that (X) is performed before one or more steps (Y1), . . . , followed by step (Z). Corresponding considerations apply when terms like “after” or “before” are used.

It will be appreciated that variations to the foregoing embodiments of the invention can be made while still falling within the scope of the invention can be made while still falling within scope of the invention. Features disclosed in the specification, unless stated otherwise, can be replaced by alternative features serving the same, equivalent or similar purpose. Thus, unless stated otherwise, each feature disclosed represents one example of a generic series of equivalent or similar features.

Use of exemplary language, such as “for instance”, “such as”, “for example” and the like, is merely intended to better illustrate the invention and does not indicate a limitation on the scope of the invention unless so claimed. Any steps described in the specification may be performed in any order or simultaneously, unless the context clearly indicates otherwise.

All of the features and/or steps disclosed in the specification can be combined in any combination, except for combinations where at least some of the features and/or steps are mutually exclusive.

In particular, preferred features of the invention are applicable to all aspects of the invention and may be used in any combination.

The expressions “detection arrangement” and “detecting arrangement” are meant to have the same meaning and describe an identical element of the system.

Below, system embodiments will be discussed. These embodiments are abbreviated by the letter “S” followed by a number. When reference is herein made to a system embodiment, those embodiments are meant.
S01: A tubal measuring arrangement (1) for measuring the flow rate (F) of fluid comprising ions, the measuring arrangement (1) comprising
   a. at least one permanent magnet (100) adapted to maintain a magnetic field (B) substantially perpendicular to the flow (F) of the fluid;
   b. at least one first detecting arrangement (200) being positioned substantially perpendicular to the magnetic field (B) and configured to conduct at least one first measurement;
   c. at least one first measuring circuit (500);
   d. at least one second detecting arrangement (400) being positioned substantially along the direction of flow (F) of the fluid;
   e. at least one second measuring circuit (600) that is configured to conduct at least one second measurement at the second measuring arrangement (400);
   f. at least one evaluation unit (700); and
   g. at least one control unit (800).
S02: The measuring arrangement (1) according to the preceding embodiment, wherein the first detecting arrangement (200) comprises at least two electrodes (210).
S03: The measuring arrangement (1) according to any of the preceding embodiments, wherein the second detecting arrangement (400) comprises at least two electrodes (410).
S04: The measuring arrangement (1) according to any of the preceding embodiments, wherein one of the second electrodes (410) is identical with one of the first electrodes (210).
S05: The measuring arrangement (1) according to any of the preceding embodiments, wherein the first measuring circuit (500) is identical with the second measuring circuit (600).
S06: The measuring arrangement (1) according to any of the preceding embodiments, wherein at least one resistor (R) is connected in parallel to the first detecting circuit (200).
S07: The measuring arrangement (1) according to any of the preceding embodiments, wherein at least one switch (300) is connected in parallel to the resistor (R) and the first detecting arrangement (200) adapted to close and release a short circuit to the first detecting arrangement (200).
S08: The measuring arrangement (1) according to any of the preceding embodiments, wherein the first measurement and/or the second measurement is at least one of
   a) a voltage (U); and/or
   b) an electric current (I); and/or
   c) an electric charge (Q) or a charge transfer (Q).
S09: The measuring arrangement (1) according to any of the preceding embodiments, wherein the second measuring arrangement (400) is angled against the magnetic field (B) by less than 90°, preferably at most 45°, more preferably at most 10°, most preferably around 0°.
S10: The measuring arrangement (1) according to any of the preceding embodiments, wherein the evaluation unit (700) and/or the control unit (800) comprises at least one timer module and/or is adapted to perform at least one control signal.
S11: The measuring arrangement (1) according to any of the preceding embodiments, wherein the first measuring circuit (500) and/or the second measuring circuit (600) comprise an analogue to digital converter.
S12: The measuring arrangement (1) according to any of the preceding embodiments, wherein the at least one second detecting arrangement (400) is adapted to be substantially parallel to the magnetic field (B) and/or parallel to the flow (F) of the fluid.
S13: The measuring arrangement (1) according to any of the preceding embodiments, wherein the resistor (R) is integral part of the first detecting arrangement (500).
S14: The measuring arrangement (1) according to any of the preceding embodiments, wherein the fluid comprises water, preferably at least one of clean water, grey water or black water.
S15: The measuring arrangement (1) according to any of the preceding embodiments, wherein at least the surface of the at least one first electrode(s) (210) and/or at least one second electrode (410) comprise(s) an electrically conducting material that is substantially inert to dissolution by the fluid.
S16: The measuring arrangement (1) according to any of the preceding embodiments, wherein at least the surface of the at least one first electrode(s) (210) and/or at least one second electrode (410) comprise(s) an electrically conducting material that is substantially inert to chemical reaction with the fluid.
S17: The measuring arrangement (1) according to embodiment S16, wherein the electrically conducting material is at least one of
   a. gold;
   b. platinum;
   c. titanium;
   d. stainless steel;
   e. polymer;
   f. ceramic;
   g. carbon nanotubes.
S18: The measuring arrangement (1) according to any of the preceding embodiments, wherein the first control circuit (500) and/or the second control circuit is adapted to apply a second voltage to the first electrode(s) (210) and/or to the second electrode(s) (410) that is of opposite polarity to the polarity of the first voltage that is induced by the flow (F) of the fluid through the magnetic field (B) and/or an alternating voltage.
S19: The measuring arrangement (1) according to embodiment S18, wherein the second voltage is applied in at least one surge that is significantly higher than the voltage(s) applied by the first voltage that is applied by the magnetic field (B).
S20: The measuring arrangement (1) according to any of the preceding embodiments, wherein the fluid has a conductivity of at least 0,5 pS/cm.
S21: The measuring arrangement (1) according to any of the preceding embodiments, wherein the evaluation unit (700) is adapted to compute at least the readouts of the first measuring unit (500) and/or the readouts of the second measuring unit (600).
S22: The measuring arrangement (1) according to the preceding embodiment, wherein the evaluation unit (700) is further adapted to modify the signals provided by the first measuring circuit (500) and/or by the second measuring circuit (600), preferably by at least one of a filter algorithm, a smoothening algorithm or a selection algorithm.
S23: The measuring arrangement (1) according to any of the embodiments S21 to S22, wherein the filter algorithm is at least one of a Kalman filter, a Particle filter and/or a compressed sensing algorithm.
S24: The measuring arrangement (1) according to any of the embodiments S21 to S23, wherein the evaluation unit (700) displays its at least one result of the processed signals, stores and/or transmits its at least one result via a network and/or conveys its at least one result to the control unit (800).
S25: The measuring arrangement (1) according to any of the embodiments S21 to S24, wherein the evaluation unit (700) is adapted to receive signals from a network, the signal being at least one of a control signal or an adjusting signal.
S26: The measuring arrangement (1) according to any of the embodiments S21 to S25, wherein a sensor detecting a magnetic field is placed on and/or in the measuring arrangement (1) detecting any changes to the magnetic field (B) and transmitting its readout to the evaluation unit (700) and/or to the control unit (800).
S27: The measuring arrangement (1) according to any of the preceding embodiments, wherein the evaluation unit (700) and at least the first measuring circuit (500) and/or the second measuring circuit (600) form one integrated circuit.
S28: The measuring arrangement (1) according to any of the embodiments S21 to S27, wherein the evaluation unit (700) is adapted to integrate the detection of a change of the magnetic field (B) into its computations.
S29: The measuring arrangement (1) according to any of the preceding embodiments, wherein the control unit (800) is adapted to receive data from at least one
   a) the evaluation unit (700);
   b) the sensor detecting a magnetic field;
   c) control panel.
S30: The measuring arrangement (1) according to any of the preceding embodiments, wherein the control unit (800) is adapted to control at least one of
   a) a display unit;
   b) the switch (300);
   c) an external relay.
S31: The measuring unit (1) according to any of the preceding embodiments, wherein the timer module (T) is adapted to initiate at least one control signal to the switch (300) that initiates the release and/or closure of a short circuit status within the first detecting arrangement (200).
S32: The measuring unit (1) according to any of the preceding embodiments, wherein the timer module is adapted to carry out control signals with a period of less than 10 s, preferably less than 1 s, more preferably less than 10 ms, more preferably less than 1 ms and at least 1 μs, most preferably around 100 ns-100 μs.
S32: The measuring arrangement (1) according to any of the preceding embodiments, wherein the evaluation unit (700), the control unit (800) and at least the first measuring circuit (500) and/or the second measuring circuit (600) form one integrated circuit.
S33: The measuring arrangement (1) according to any of the preceding embodiments, wherein the measuring arrangement (1) is supplied with at least one grounding ring upstream and/or downstream of the tubal measuring arrangement (1) that houses at least the first and/or the second detection arrangement (200, 400) and/or is used to supply a defined potential to the any component.
S34: The measuring arrangement (1) according to any of the preceding embodiments, wherein the evaluation unit (700) comprises at least one storage comprising tabular data.

Below, maintenance method embodiments will be discussed. The letter M followed by a number abbreviates the method embodiments. Whenever reference is herein made to method embodiments, these embodiments are meant.
M01: A method to measure the flow rate (F) of a fluid comprising ions comprising the steps of
   a. providing a magnetic field (B) by a permanent magnet substantially perpendicular to the flow of the fluid (F), the magnetic field (B);
   b. conducting at least one first measurement by providing at least one first measuring arrangement (200) being positioned substantially perpendicular to the magnetic field (B);
   c. providing at least one first measuring circuit (500);
   d. providing at least one second detecting arrangement (400) being positioned substantially along the direction of flow (F) of the fluid;
   e. conducting at least one measurement by providing at least one second measuring circuit (600);
   f. conducting at least one evaluation by providing at least one evaluation unit (700); and
   g. providing at least one control unit (800).
M02: A method to measure the flow rate (F) of a fluid comprising ions comprising the steps of
   a. providing a magnetic field (B) by a permanent magnet substantially perpendicular to the flow of the fluid (F), the magnetic field (B);
   b. conducting at least one first measurement by providing at least one first measuring arrangement (200) being positioned substantially perpendicular to the magnetic field (B);
   c. providing at least one first measuring circuit (500);
   d. conducting at least one evaluation by providing at least one evaluation unit (700) and
   e. conducting at least one control signal by providing at least one control unit (800).

### DESCRIPTION OF THE FIGURES

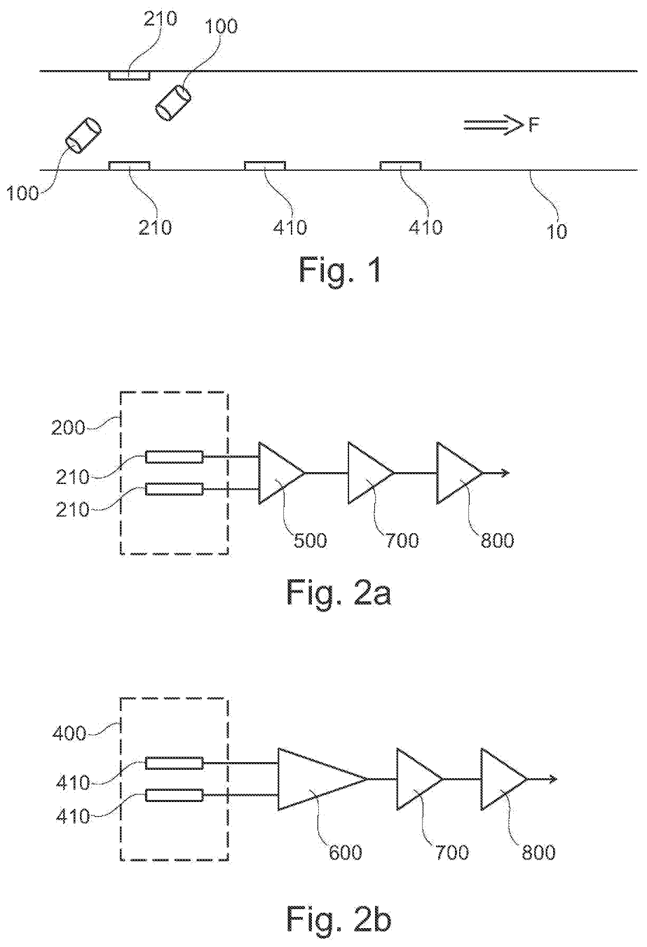

FIG. 1 depicts a schematic view, how the mechanical elements of a tubal measuring arrangement 1 (also referred as tube) are located in relation to each other in one embodiment. The pipe 10 consists of a material that is substantially transparent for a magnetic field and does not conduct electricity. At least one magnet 100 is placed outside on or close to the surface of the pipe 10. The axis of the magnetic field B supplied by the at least one magnet 100 shall be pointing in an orthogonal orientation to the direction of the flow F of the fluid. Preferably, a second magnet is provided for, the orientation of the magnets so that they increase the magnetic field, thus the north pole of the one magnet being oriented to the south pole of the second magnet. If two magnets are supplied, they can advantageously be placed with their axes of the magnetic field B in line, however one magnet on either side of the measuring arrangement 1. It should be noted that while two magnets in line forming one resultant magnetic field B may be a preferred configuration, it is not mandatory to place the magnets in line; it should however be provided for the existence of a magnetic field B covering at least an area within the tube where a fluid flow F through.

Two electrodes 210 forming a pair of electrodes are placed inside the tube 1 and in contact with the fluid. The imaginary line between one pair of first electrodes 210 can also be referred to as axis E. More than one pair of electrodes can be supplied to form more than one axis. A first electrode 210 can be a strip of an electrically conducting material. Such a strip may be glued or otherwise secured to the inside of the tube. Each first electrode 210 and/or second electrode 410 is connected to the outside of the tube to establish a galvanic connection with external elements disclosed otherwise.

The shape of the first electrodes 210 and/or the second electrodes 410 is not restricted to be flat. The first electrodes 210 and/or the second electrodes 410 can show any shape that on the one hand constitute a good galvanic contact to the fluid; on the other hand, a minimum of turbulence to the fluid shall be affected.

Further, if a strip is selected to be a first electrode 210 and/or a second electrode 410, the orientation of the axis E is meant to be substantially orthogonal to the flow F of the fluid and also substantially orthogonal to the magnetic field B. The mutual relation of the three axes E, F and B is displayed in FIG. 6 for a better reference.

The second electrodes 410 are positioned in a substantially parallel line with the flow F of the fluid. As an alternative, or additionally, the second electrodes 410 may be positioned substantially parallel to the line of magnetic flow B. Variations in the relational angles are acceptable, as long as a least possible tension or current is induced by the motion of the ions (or electrons) that flow with the fluid in the flow F passing the magnetic field B.

It should be clear that the direction of the flow F is along the mechanical dimension of the tube 1. It is not significant whether the flow F directs into the one direction or into the opposite direction.

FIG. 2a depicts an embodiment showing the schematic electric relation of several components of the tubal measurement arrangement 1 (again, for brevity reasons referenced as tube 1). The first electrodes 210 are pairwise organized as the first detection arrangement 200. Several first detection arrangements 200 can be provided to reduce the influence of a disturbing signal, to surveil the integrity of other electrodes and/or the whole tube 1. The first detection arrangement 200 delivers the induced tension or current via galvanic connectors to a first measuring circuit 500. Such a first measuring circuit 500 may be an analogue to digital converter (ADC), a device that converts an analogue value that is delivered by the first detection arrangement 200 into a digital value. The functionality of such an ADC is assumed to be known by the person skilled in the art.

Periodically, an analogue value is digitized and delivered to an external device that handles the digital value. In this embodiment, the digital value delivered by the first measuring circuit 500 is transferred to an evaluation unit 700. Again, if more than one first measuring circuit 500 is supplied, more than one evaluation units can be assigned. Further, the first measuring circuits 500 can deliver their readouts to the evaluation unit in a time-sharing method, thus a switch is added between the first measuring circuit(s) 500 and the evaluation unit 700. The switch (not depicted) can select which first measuring circuit 500 delivers its readout to the evaluation unit 700.

The evaluation unit 700 carries out evaluations that are disclosed in more detail in the description portion of this application.

Further, the evaluation unit 700 delivers its results to a control unit 800. This control unit sends out the results received from the evaluation unit 700 to a display. Additionally, or alternatively, the control unit 800 may carry out further control functions, such can be the initiation of an alarm signal if, for instance, if irregular conditions are determined by the evaluation unit 700 on the basis of the measurements of the preceding components of the tube.

A timer (not depicted) may be provided to carry out various functions. The timer may initiate phases of measurement by the first measuring circuit 500 or may initiate whatever coordinating or timing signal as appropriate.

FIG. 2b depicts an embodiment showing the schematic electric relation of several components of the tubal measurement arrangement 1 (again, for brevity reasons referenced as tube 1). The second electrodes 410 are pairwise organized as the second detection arrangement 400. Several second detection arrangements 400 can be provided to reduce the influence of a disturbing signal, to surveil the integrity of other electrodes and/or the whole tube 1. The second detection arrangement 400 delivers the induced tension or current via galvanic connectors to a second measuring circuit 600. Such a second measuring circuit 600 may be an analogue to digital converter (ADC), a device that converts an analogue value that is delivered by the second detection arrangement 400 into a digital value. The functionality of such an ADC is assumed to be known by the person skilled in the art. Periodically, an analogue value is digitized and delivered to an external device that handles the digital value. In this embodiment, the digital value delivered by the second measuring circuit 600 is transferred to an evaluation unit 700. Again, if more than one second measuring circuit 600 is supplied, more than one evaluation units can be assigned. Further, the second measuring circuits 600 can deliver their readouts to the evaluation unit in a time-sharing method, thus a switch is added between the second measuring circuit(s) 600 and the evaluation unit 700. The switch (not depicted) can select which second measuring circuit 600 delivers its readout to the evaluation unit 700.

The evaluation unit 700 carries out evaluations that are disclosed in more detail in the description portion of this application.

Further, the evaluation unit 700 delivers its results to a control unit 800. This control unit sends out the results received from the evaluation unit 700 to a display. Additionally, or alternatively, the control unit 800 may carry out further control functions, such can be the initiation of an alarm signal if, for instance, if irregular conditions are determined by the evaluation unit 700 on the basis of the measurements of the preceding components of the tube.

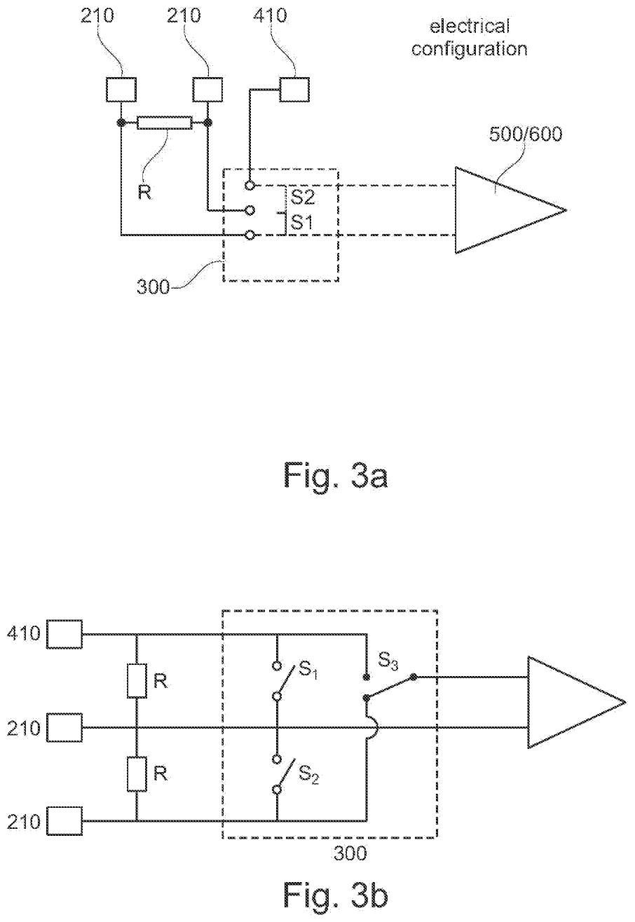

FIG. 3a depicts an embodiment where resistance R makes it clear that in this embodiment not a current but a tension is measured at the first electrodes 210. A second electrode 410 works pairwise with one of the first electrodes 210 in a time-sharing method. A switch 300 selects whether the first electrodes are analyzed (first channel) or the second electrode 410 against the one first electrode 210 (second channel). The switch 300 may be driven by a timer module (not depicted) or have an internal logic to select the first or the second channel. The sharing of one electrode by two measuring channels is possible because the orientation of the first electrodes 210 is substantially perpendicular with the orientation of the second electrodes 410. Thus, placing one of the electrodes, in this embodiment a first electrode 210, can be placed in the origin of the spatial coordinate system (see FIG. 6) and thus take over also the function of one part of the second electrodes 410.

In a first state S1 of the switch 300 the two electrodes 210 are short circuited. In this state S1 at the entry of the first measuring circuit 500 the tension between the one second electrode 410 and one of the first electrodes 210 is measured. This is the tension that is substantially independent from the magnetic influence, because the orientation of the one first electrode 210 and the one second electrode 410 is arranged to be either parallel to the magnetic field B or parallel to the flow F of the fluid and thus be less affected by the magnetic field B. This ensures that a minimum of the induced tension is detected but overweighing the noise tension that is induced by electro-chemical effects.

The first measuring circuit 500 and/or an evaluation unit (not depicted) may store the value of the noise tension.

In a second state S2 of the switch 300 the one second electrode 410 is short circuited with one of the first electrodes 210. In this state S2, no tension can be conveyed to the first measuring circuit 500, but only the tension between the first electrodes 210 can be detected by the first measuring circuit 500.

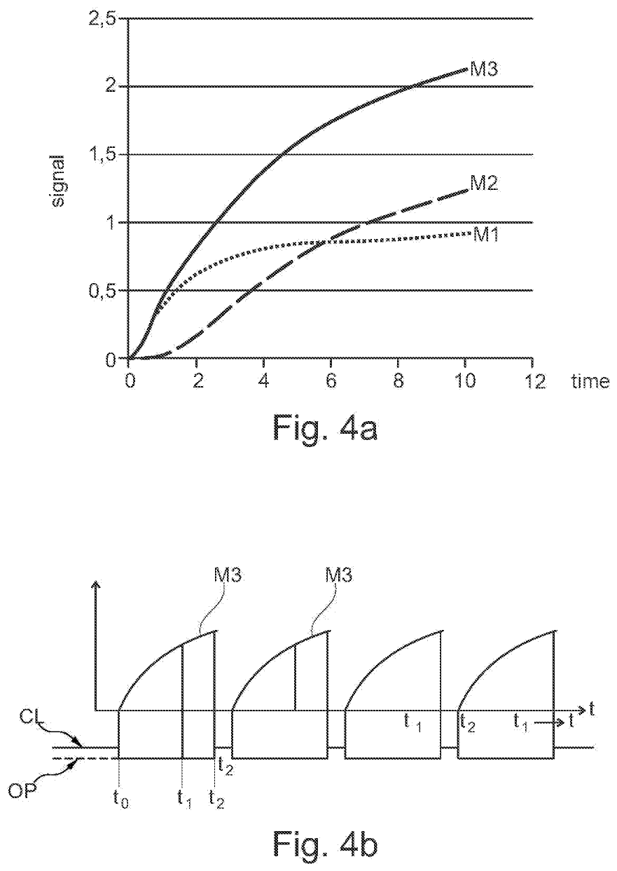

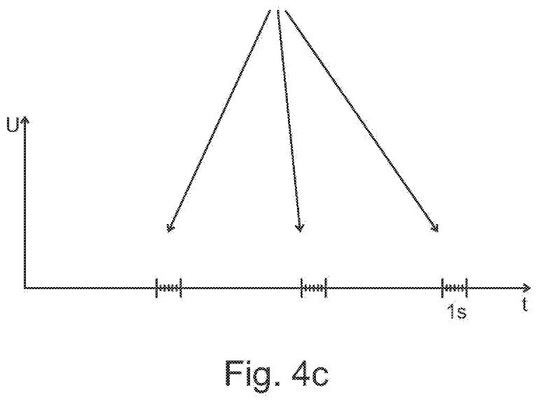

In the state S2, when the tension between the first electrodes 210 is detected, this is the tension that is induced by the flow F of the fluid in the magnetic field B plus the tension that is induced by electro-chemical affect. Thus, the tension measured between the first electrodes 210 is a resultant (usually the sum) of the induced, useful signal and the electro-chemically induced noise tension. A subsequent logic component can substantially subtract the two values and thus harvest the useful tension. The relation of the useful tension, the noise tension and the resultant tension is depicted as family of curves in FIG. 4a.

Generally, it should be clear to the person skilled in the art that an induced tension is substantially in direct relation to an induced current. Thus, for the results sake it doesn't matter whether a tension or a current is measured.

The analogue value(s) delivered by the first electrodes 210 and the second electrode 410, via the switch 300, is fed into the first measuring circuit 500. In this embodiment, a second measuring circuit 600 is not provided.

The digital value delivered by the first measuring circuit 500 is conveyed to a subordinate arrangement or device.

FIG. 3b depicts a portion of an arrangement where only one first measuring circuit 500 is provided. The switches S1, S2 and S3 are coordinated. S3 selects the circuit that is to be analyzed (either the combination of a first electrode 210 with a second electrode 410, or by the combination of two first electrodes 210) the subordinate arrangement or device, in this embodiment the first measuring device 500. As can be determined from the two resistors R1 and R2, a voltage (or tension) is measured.

FIG. 4a depicts a family of theoretical curves that represent the components of tensions or currents that are induced by varied cause.

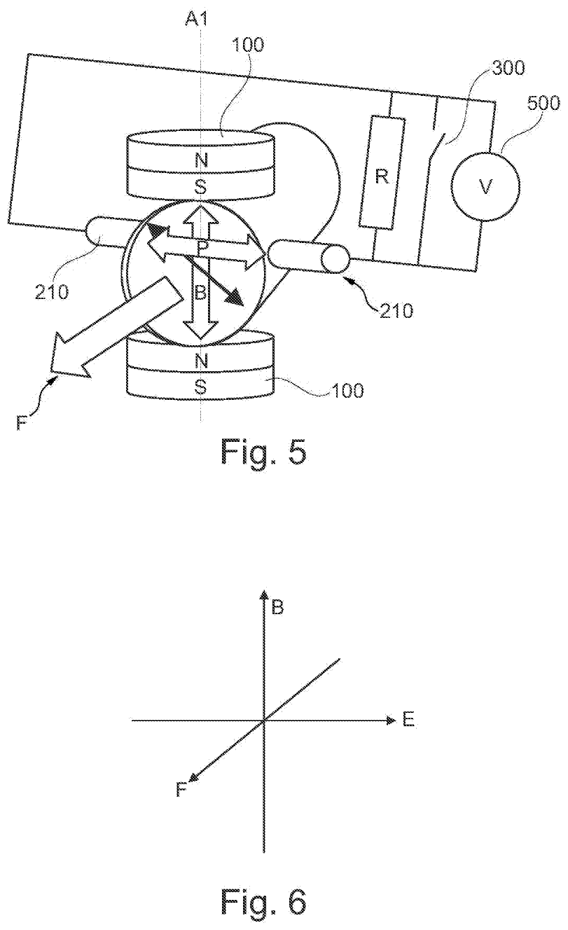

The first electrodes 210 detect a resultant tension M3—the one tension M1 that is induced by the flow F (FIG. 5) of the fluid within the magnetic field B (FIG. 5) and further a tension M2 that is induced by electro-chemical effect. This tension M3 illustrated over the time t is represented by the steady line.

The second electrodes 410 (FIG. 1) detect a noise tension M2 only, as explained in detail elsewhere. As can be seen from the curves, the tension M1 rises earlier than tension M2.

A subsequent evaluation unit (see FIGS. 2a and 2b) takes care of those two tensions M2 and M3 and evaluates the useful signal M1 that is displayed as a dotted line. Usually, the noise tension M2 that is harvested from the second electrodes (not depicted) is subtracted from the overall tension M3 that is harvested from the first electrodes (not depicted). The result is a useful tension M1.

It should be clear that this description is a simplified representation only. Filter and/or selection algorithms may be applied, consistency checks may be carried out; certain values may be neglected, other values may be applied with factors that may improve the quality of the resulting tension curve M1.

FIG. 4b depicts a diagram of an induced tension M3 over the time t in one embodiment. In the below portion of the diagram a state of a switch is shown. The upper state means the switch is closed (short circuit on the first electrodes), the lower state means the switch is opened (short circuit of the first electrodes released).

At the position in the diagram of t₀ the short circuit between the first electrodes is released for a period of time that ends at t₂. At t₂ the short circuit is established again. Between t₁ and t₂ the measurements of M3 are taken.

The measuring cycle between two time stamps t₀can be repeated multiply according to the discretion of the manufacturer. Usually, a certain amount of measurement cycles should be taken to allow the evaluation unit (not depicted) to detect irregularities and/or developments and to reduce noise.

FIG. 4c A sequence of measurement cycles can be initiated by a controlling instance (not depicted) like a timer module. In this embodiment, a sequence of measurements has been selected to measure three times per second. It should be clear that this represents one example only. More cycles may be selected or less, according to the specific needs.

FIG. 5 depicts a 3D embodiment where only the first electrodes 210 are in use. The permanent magnets 100 (the numbering “N” and “S” shall represent the polarities of the magnets) are situated at the tubal measuring arrangement 1 on the outer surface 10 of the tube. The small letter d shall indicate the inner diameter of a tube-shaped measuring arrangement 1. The first electrodes 210 in this embodiment pass through the wall of the tube to get in touch with the fluid. The first electrodes 210 are positioned in a way to comprise a substantially orthogonal orientation to both, the magnetic field B and the flow F of the fluid. The electrodes can be positioned eccentrically, as can be seen. A resistor R in this embodiment can be a discrete element or be achieved by the inner resistance of the first measuring circuit 500. A switch 300 is positioned parallel to the first electrodes 210 and to the resistor R. The switch 300 is adapted to short circuit the tension/current that is induced by the flow F of the fluid while it flows through the magnetic field B and an electro-chemically induced tension. The harvested tension that is detected by the first electrodes 210 is a resultant of the two sources of tension. In this embodiment, the electro-chemically induced tension cannot be detected directly. An evaluation unit (not depicted) that is logically positioned behind the first measuring circuit 500 may have tabular dates about the characteristics of the electro-chemical tension over the time lapsed during measurement to reduce the detected tension (see FIG. 4a, there marked as M3). Such a look-up table may be stored in an element of the evaluation unit (not depicted) and thus acquire data that can be assumed to be useful data, useful for various reasons.

It should be clear that the magnets can be configured also opposite of the depicted arrangement, i.e., the North—and the South poles of the magnets can be reversed, as long as a substantially homogeneous magnet field is achieved.

FIG. 6 shows a representation of a three-dimensional coordinate system. The person skilled in the art will know about the Lorentz rule, which says that the flow F of a fluid must be substantially orthogonal to a magnetic field B and also substantially orthogonal to the imaginary line between the electrodes E.

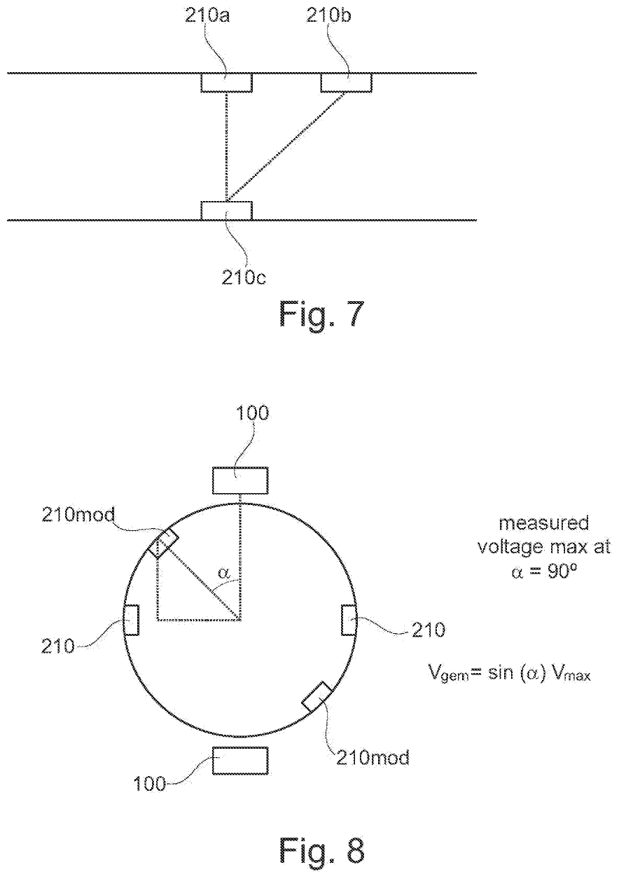

FIG. 7 represents a detailed view of how the first electrodes 210 (not depicted) can be arranged. The tension between the first electrode 210a and 210c is comparable, if not equal, to a tension measured between an allocation of a first electrode 210c and 210b. Thus, the pair of first electrodes 210 (not depicted here) doesn't need to be located opposingly.

FIG. 8 demonstrates that the first electrodes 210 do not necessarily have to be placed orthogonally to the magnetic flux. If the first electrodes 210 mod are placed angled to the magnetic flux, a sine value of the angle α can be applied to the measured value to receive a more suitable value for further calculations.

1-19. (canceled)

20. A tubal measuring arrangement for measuring the flow rate of fluid comprising ions, the measuring arrangement comprising
at least one permanent magnet adapted to maintain a magnetic field substantially perpendicular to the flow of the fluid;
at least one first detecting arrangement being positioned substantially perpendicular to the magnetic field and configured to conduct at least one first measurement;
at least one first measuring circuit;
at least one second detecting arrangement being positioned substantially along the direction of flow of the fluid;
at least one second measuring circuit that is configured to conduct at least one second measurement at the second measuring arrangement;
at least one evaluation unit; and
at least one control unit.

21. The tubal measuring arrangement according to claim 20, wherein the first detecting arrangement comprises at least two first electrodes.

22. The tubal measuring arrangement according to claim 20, wherein the second detecting arrangement comprises at least two second electrodes.

23. The tubal measuring arrangement according to claim 20, wherein one of the second electrodes is identical with one of the first electrodes.

24. The tubal measuring arrangement according to claim 20, wherein the first measuring circuit is identical with the second measuring circuit.

25. The tubal measuring arrangement according to claim 20, wherein at least one resistor is connected in parallel to the first detecting arrangement.

26. The tubal measuring arrangement according to claim 20, wherein at least one switch is connected in parallel to the resistor and the first detecting arrangement adapted to close and release a short circuit to the first detecting arrangement.

27. The tubal measuring arrangement according to claim 20, wherein a first measurement of the first measuring arrangement and/or a second measurement of the second measuring arrangement is at least one of
a voltage; and/or
an electric current; and/or
an electric charge or a charge transfer.

28. The tubal measuring arrangement according to claim 20, wherein the second measuring arrangement is angled against the magnetic field by at most 10°.

29. The tubal measuring arrangement according to claim 20, wherein the second measuring arrangement is angled against the magnetic field by less than 45°.

30. The tubal measuring arrangement according to claim 20, wherein the evaluation unit and/or the control unit comprises at least one timer module and/or is adapted to perform at least one control signal.

31. The tubal measuring arrangement according to claim 20, wherein the first measuring circuit and/or the second measuring circuit (600) comprise an analogue to digital converter.

32. The tubal measuring arrangement according to claim 20, wherein the at least one second detecting arrangement is adapted to be substantially parallel to the magnetic field and/or parallel to the flow of the fluid.

33. The tubal measuring arrangement according to claim 20, wherein the electrically conducting material is substantially inert to chemical reaction with the fluid, the material being preferably at least one of
gold;
platinum;
titanium;
stainless steel;
polymer;
ceramic;
carbon nanotubes.

34. The tubal measuring arrangement according to claim 20, wherein the evaluation unit is adapted to compute at least the readouts of the first measuring unit and/or the readouts of the second measuring unit.

35. The tubal measuring arrangement according to claim 34, wherein the evaluation unit is further adapted to modify the signals provided by the first measuring circuit and/or by the second measuring circuit, preferably by at least one of a filter algorithm, a smoothening algorithm or a selection algorithm, the algorithm being at least one of a Kalman filter,
a particle filter or
a compressed sensing algorithm.

36. The tubal measuring arrangement according to claim 20, wherein the evaluation unit and at least the first measuring circuit and/or the second measuring circuit form one integrated circuit.

37. The tubal measuring arrangement according to claim 20, wherein the timer module is adapted to initiate at least one control signal to the switch that initiates the release and/or closure of a short circuit status within the first detecting arrangement.

38. The tubal measuring arrangement according to claim 20 wherein the timer module is adapted to carry out control signals with a period of less than 1 s and more than 1 ms.

39. The tubal measuring arrangement according to claim 20, wherein a sensor detecting a magnetic field is placed on and/or in the measuring arrangement detecting any changes to the magnetic field and transmitting its readout to the evaluation unit and/or to the control unit.

40. A method to measure the flow rate of a fluid comprising ions comprising the steps of
providing a magnetic field by a permanent magnet substantially perpendicular to the flow of the fluid, the magnetic field;
conducting at least one first measurement by providing at least one first measuring arrangement being positioned substantially perpendicular to the magnetic field;
providing at least one first measuring circuit;
providing at least one second detecting arrangement being positioned substantially along the direction of flow of the fluid;
conducting at least one measurement by providing at least one second measuring circuit;
conducting at least one evaluation by providing at least one evaluation unit; and
providing at least one control unit.
